(19) United States
(12) Patent Application Publication
(10) Pub. No.: US 2011/0281066 A1
(43) Pub. Date: Nov. 17, 2011

(54) LIGHTWEIGHT FIRE RESISTANT COVERING FOR STRUCTURES

(76) Inventors: Rodney Andrews, Lexington, KY (US); Mark Meier, Nicholasville, KY (US); Thomas A. Golubic, Boardman, OH (US); Paul E. Yeary, Pippa Passes, KY (US)

(21) Appl. No.: 12/779,526

(22) Filed: May 13, 2010

(51) Int. Cl. B32B 3/26; B05D 3/02; B32B 3/10

(52) U.S. Cl. 428/141; 428/319.3; 428/172; 427/385.5; 427/379

(57) ABSTRACT

A building panel, a shingle and a flooring tile are all provided including a reticulated foam body having a weather resistant coating made from a material selected from a group consisting of a polymer, a ceramic glaze and mixtures thereof. In addition, a method of producing these products is also provided.

### TECHNICAL FIELD

The present invention relates generally to the building products field and, more particularly, to a new and improved building panel, shingle, flooring tile and method for producing the same.

### BACKGROUND OF THE INVENTION

Wild fires destroy vast amounts of real estate, which often leads to the loss of lives and incredibly high insurance losses. In many cases, natural conditions are conducive to the wild fire risk. For example, during certain parts of the year, dry and windy conditions persist in some areas of California and other states. Specifically, California wild fires are often fanned and spread rapidly by strong winds creating raging infernos. It is not uncommon for temperatures in such infernos or fire storms to reach the range of 800-1200° C. Some fires possibly reach temperatures over 2200° C.

Asphalt shingles are the most common roofing material in the United States accounting for over 60% of the market. Although these materials are fire resistant, they are not fireproof and may be ignited by embers and hot gases from approaching fires. Concrete, clay tiles and slate tiles are more resistant to fire, but these materials are heavy and their use often requires upgrades to the support structure that are quite expensive. In addition, such materials are inappropriate for use in earthquake-prone areas, such as found in markets like California. More specifically, the relatively heavy roofing materials have a strong potential to become dangerous falling debris in the event of a tremor or earthquake. Metal roofing is yet another option. While metal roofing is fire resistant, it suffers from a significant disadvantage in that it efficiently conducts heat from burning embers to the underlying structure. In addition, the heat conduction of a metal roof leads to greater air conditioning demands during hot summer months resulting in undesirable, increased energy bills. In view of all of these shortcomings, it should be easily appreciated that a new and improved roofing material option is needed.

Toward this end, efforts have been made to develop reticulated foam based building panels and products characterized by light weight and good fire resistance. Examples of such efforts may be found, for example, in U.S. Pat. Nos. 4,430,108 to Hojaji et al, and 7,393,577 to Day et al as well as in published U.S. patent application no. 2007/0154702 to Miller et al. The present invention relates to new and improved building panels, shingles and floor coverings comprising a reticulated foam body having a weather resistant coating. Such a product is characterized by excellent fire resistance, low thermal conductivity for reduced heating and cooling requirements and light weight. The coating process also provides a desirable texture and color to the product thereby enhancing its aesthetic appeal.

### SUMMARY OF THE INVENTION

In accordance with the purposes of the present invention as described herein, a building panel is provided comprising a reticulated form structure including a weather resistant coating made from a material selected from a group consisting of a polymer, a ceramic glaze and mixtures thereof. For purposes of this document, “weather resistant” means resistant to weather, sun light deterioration, heat, cold and freezing conditions. In one particularly useful embodiment the reticulated foam body has a density of between about 0.3 g/mL and about 2.0 g/mL. The reticulated foam body is selected from a group consisting of carbon fiber, graphite fiber, ceramic fiber, polymer fiber and mixtures thereof. In yet another possible embodiment the reticulated foam body is reinforced with a material selected from a group consisting of metal fibers, mineral fibers, glass fibers, fly ash, sand and mixtures thereof.

More specifically describing the invention, the polymer used in the weather resistant coating may be selected from a group of materials consisting of an epoxy, carbon (glassy), phenolic resin, geopolymer and mixtures thereof. Where the weather resistant coating is a ceramic glaze, that glaze may be made from a material selected from a group consisting of silicate, calcium magnesium silicate, aluminum silicate, alumina silicate, limestone, calcite-ground limestone, clay, bentonite clay, coal combustion byproducts and mixtures thereof. In one particularly useful embodiment the weather resistant coating has a thickness of between about 0.5 mm and about 5.0 mm and the coated reticulated foam body has a density of between about 0.3 g/mL and about 1 g/mL.

In accordance with yet another aspect of the present invention, a shingle is provided comprising a reticulated foam body including a weather resistant coating made from a material selected from a group consisting of a polymer, a ceramic glaze and mixtures thereof. The weather resistant coated reticulated foam body tapers from a first end to a second end. In one particularly useful embodiment the weather resistant coated reticulated foam body has a thickness of between about 0.5 mm and about 5.0 mm at the first end and between about 1.0 cm and about 3.0 cm at the second end.

In accordance with yet another aspect of the present invention, a flooring tile is provided comprising a reticulated foam body including a weather resistant coating made from a material selected from a group consisting of a ceramic glaze, and a ceramic and polymer glaze imparting a desired texture and color to an exposed face of the reticulated foam body.

In still yet another aspect of the present invention a method is provided for producing a building panel. The method comprises the steps of shaping a body of reticulated foam to a desired shape, applying a first ceramic glaze coating to a surface of the shaped body of reticulated foam and firing the first ceramic glaze coating in order to set said first ceramic glaze coating to said surface of said shaped body of reticulated foam. Still further, the method may also include drying the first ceramic glaze coating and applying a second ceramic glaze coating over the first ceramic glaze coating before the firing process is completed.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a cross sectional view of a building panel constructed in accordance with the teachings of the present invention;

FIG. 2 is a cross sectional view of a shingle constructed in accordance with the teachings of the present invention; and

FIG. 3 is a perspective view of a flooring tile constructed in accordance with the teachings of the present invention.

Reference will now be made in detail to the present preferred embodiment of the invention, examples of which are illustrated in the accompanying drawings.

### DETAILED DESCRIPTION OF THE INVENTION

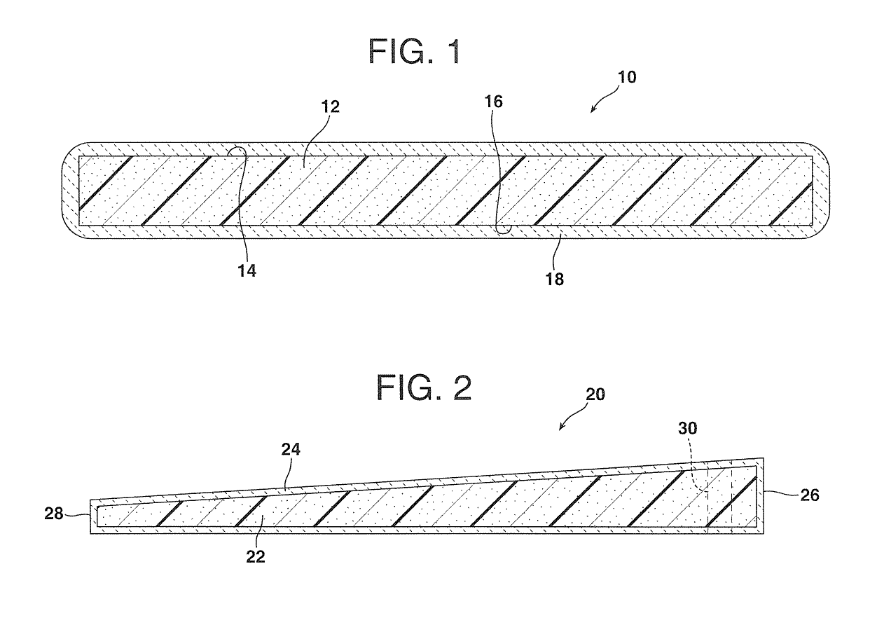

Reference is now made to FIG. 1 illustrating in cross section a building panel 10 constructed in accordance with the teachings of the present invention. The building panel 10 may be used, for example, as a wall panel, a flooring panel, a ceiling panel or a roofing panel in residential, commercial and industrial construction. Advantageously, the panel 10 is lightweight, durable and very fire resistant. Further, the building panel 10 may be quickly produced in a relatively inexpensive manner. In addition, it may be readily produced with substantially any desired texture and color to provide the aesthetic appeal sought by today's consumers.

As illustrated, the building panel 10 comprises a reticulated foam body 12 having a front face 14 and a rear face 16. The reticulated foam body 12 includes a weather resistant coating 18 at least on the front or exposed face 14 of the building panel. In the embodiment illustrated in FIG. 1, the weather resistant coating 18 completely surrounds and envelopes the reticulated foam body 12.

The reticulated foam body 12 is constructed from a material selected from a group consisting of carbon, carbon fiber, graphite fiber, ceramic, ceramic fiber, polymer fiber and mixtures thereof. The reticulated foam body 12 may be reinforced with a material selected from a group consisting of metal fibers, mineral fibers, glass fibers, carbon fibers, polymer fibers, fly ash, sand and mixtures thereof. The reticulated foam body 12 may also include other fillers and additives such as blowing agents, fire retardant agents and the like.

The reticulated foam body 12 has an open structure with cells or pores typically having a diameter of between about 0.1 mm and about 7 mm. The reticulated foam body 12 typically has a density of between about 0.3 g/mL and about 2.0 g/mL. For most applications the reticulated foam body 12 has a thickness of between about 8 mm and about 30 mm.

The weather resistant coating 18 is made from a material selected from a group consisting of a polymer, a ceramic glaze and mixtures thereof. Polymers useful for the weather resistant coating 18 include, but are not limited to, materials selected from a group consisting of epoxy, carbon (glassy), phenolic resin, geopolymer, and mixtures thereof. Ceramic glaze useful in the weather resistant coating 18 include, but are not limited to, materials selected from a group consisting of silicate, calcium magnesium silicate, aluminum silicate, alumina silicate, limestone, calcite-ground limestone, clay, bentonite clay, coal combustion byproducts, and mixtures thereof. Typically the weather resistant coating 18 has a thickness of between about 0.5 mm and about 7.0 mm and the finished building panel, including the weather resistant coated, reticulated foam body 12 has a density of between about 0.3 g/mL and about 3.0 g/mL. Thus, the building panel 10 is a strong, lightweight material that is very fire resistant. It also has the durability to survive shipping with minimal breakage and the stiffness to allow convenient and efficient handling during installation.

FIG. 2 illustrates a shingle 20 incorporating a reticulated foam body 22 including a weather resistant coating 24 that preferably envelopes the foam body. The reticulated foam body 22 is made from the same materials as the reticulated foam body 12 discussed above. Similarly, the weather resistant coating 24 is made from the same weather resistant coating materials 18 discussed above.

As should be appreciated, the shingle 20 tapers from a first end 26 to a second end 28. This aids the installer when mounting the shingles to roof sheeting in an overlapping manner. Fastening holes 30 may be provided adjacent the first end 26 of the shingle 20. Such fastening holes 30 receive nails or other fasteners to secure the shingle 20 to an underlying substrate such as roof sheeting.

In one particularly useful embodiment the reticulated foam body 22 of the shingle 20 has a thickness of between about 1.0 cm and about 3.0 cm and a density of between about 0.3 g/mL and about 2.0 g/mL. The weather resistant coating 24 has a thickness of between about 0.5 mm and about 7.0 mm and the finished shingle 20 has a density of between about 0.5 g/mL and about 3.0 g/mL.

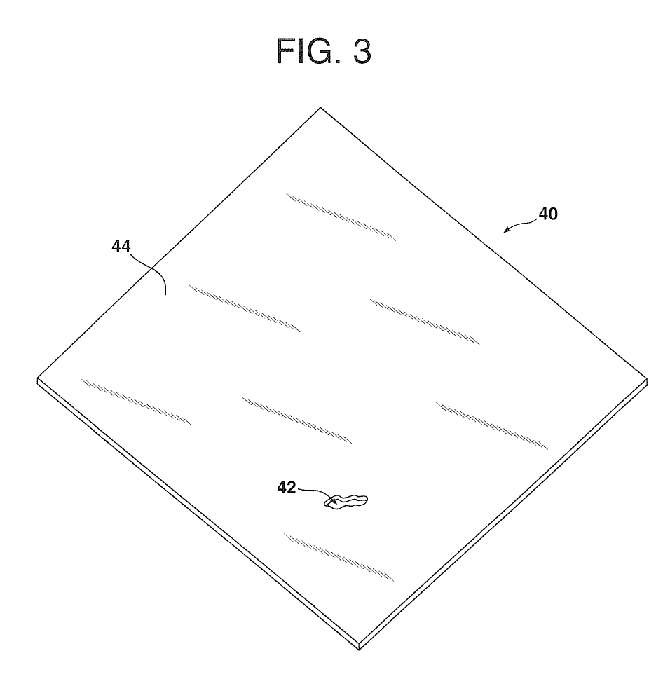

As illustrated in FIG. 3, a flooring tile 40 is provided. The flooring tile 40 includes a reticulated foam body 42 made from the same materials and having the same physical characteristics as the reticulated foam body 22 of the shingle 20 and the reticulated foam body 12 of the building panel 10.

The flooring tile 40 also includes a weather resistant coating 44 made from a material selected from a group consisting of a ceramic glaze and a ceramic and polymer glaze made from the same weather resistant coating materials discussed above with respect to the coatings 24 and 18. The weather resistant coating 44 has a thickness of between about 0.5 mm and about 7.0 mm and the finished flooring tile 40 has a density of between about 0.5 g/mL and about 3.0 g/mL.

The building panel 10, shingle 20 and flooring tile 40 may all be quickly, efficiently and inexpensively produced by an in-line manufacturing process. More specifically, the method of producing a building panel 10, shingle 20 or flooring tile 40 comprises the steps of shaping a body of reticulated foam to a desired shape, applying a first weather resistant coating to a surface of the shaped body of reticulated foam and firing the first weather resistant coating in order to set said first weather resistant coating to the surface of the shaped body of reticulated foam.

In accordance with an additional aspect of the inventive method, the method additionally includes the drying of the first weather resistant coating and applying a second weather resistant coating over the first weather resistant coating before firing. In one particularly useful embodiment each of the weather resistant coatings is a ceramic glaze coating comprising a ceramic glaze or a combined ceramic and polymer glaze. Polymers useful in the weather resistant coating include but are not limited to epoxy, carbon (glassy), phenolic resin, geopolymer and mixtures thereof. Ceramic glaze materials useful in the weather resistant coating include, but are not limited to, silicate, calcium magnesium silicate, aluminum silicate, alumina silicate, limestone, calcite-ground limestone, clay, bentonite clay, coal combustion byproducts, and mixtures thereof. More specifically, ceramic glazes particularly useful in the present invention have a cure temperature of at least 1000° C. Commercially available ceramic glazes of this type are available from Standard Ceramic Supply Company of Carnegie, PA and from Mayco Colors of Hilliard, Ohio. The commercially available glaze is prepared as the manufacturer recommends, typically diluted with water at a ratio of 1:0.25 (wt:wt). The diluted mixture is stirred or otherwise agitated thoroughly in order to keep the glassy materials of the glaze from settling out of the slurry. The shaped carbon foam body is then immersed in the slurry mixture. Next the coated, shaped reticulated foam body is dried in air or drying oven. The immersion and drying steps are repeated as often as desired to provide the desired thickness of weather resistant coating layer on the reticulated foam body in order to ensure that the foam body is completely sealed. The weather resistant coated, shaped foam body is then placed in a rapid fire furnace. The furnace is then flushed with nitrogen. The coated body is then heated in the furnace up to, for example, 1075° C. and held there, for example, for 15 minutes in order to cure the ceramic glaze/weather resistant coating. The cured, finished product is then allowed to cool to room temperature.

Alternatively, the coated, reticulated foam body may be fired at, for example, 1020° C. in air rather than nitrogen. After curing for the required time, the finished product is allowed to cool to room temperature, typically over several hours.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A building panel, comprising:
a reticulated foam body including a weather resistant coating made from a material selected from a group consisting of a polymer, a ceramic glaze and mixtures thereof.

2. The building panel of claim 1, wherein said reticulated foam body has a density of between about 0.3 g/mL and about 2.0 g/mL.

3. The building panel of claim 2, wherein said reticulated foam body is constructed from a material selected from a group consisting of carbon fiber, graphite fiber, ceramic fiber, polymer fiber and mixtures thereof.

4. The building panel of claim 3, wherein said reticulated foam body is reinforced with a material selected from a group consisting of metal fibers, mineral fibers, glass fibers, carbon fibers, polymer fibers, fly ash, sand and mixtures thereof.

5. The building panel of claim 4, wherein said weather resistant coating of polymer is selected from a group of materials consisting of an epoxy, carbon (glassy), phenolic resin, a geopolymer and mixtures thereof.

6. The building panel of claim 4, wherein said weather resistant coating of ceramic glaze is made from a material selected from a group consisting of a silicate, calcium magnesium silicate, aluminum silicate, alumina silicate, limestone calcite-ground limestone, clay, bentonite clay, coal combustion byproducts and mixtures thereof.

7. The building panel of claim 6, wherein said weather resistant ceramic glaze coating material includes a polymer.

8. The building panel of claim 1, wherein said weather resistant coating has a thickness of between about 0.5 mm and about 5.0 mm and said coated reticulated foam body has a density of between about 0.3 g/mL and about 3.0 g/mL.

9. A shingle comprising:
a reticulated foam body including a weather resistant coating made from a material selected from a group consisting of a polymer, a ceramic glaze and mixtures thereof;
said weather resistant coated reticulated foam body tapering from a first end to a second end.

10. The shingle of claim 9, wherein said weather resistant coated reticulated foam body has a thickness of between about 0.5 mm and about 5.0 mm at said first end and between about 1.0 cm and about 3.0 cm at said second end.

11. The shingle of claim 10, wherein said reticulated foam body has a density of between about 0.3 g/mL and about 2 g/mL.

12. The shingle of claim 11, wherein said reticulated foam body is constructed from a material selected from a group consisting of carbon fiber, graphite fiber, ceramic fiber, polymer fiber and mixtures thereof.

13. The shingle of claim 12, wherein said reticulated foam body is reinforced with a material selected from a group consisting of metal fibers, mineral fibers, glass fibers, carbon fibers, polymer fibers, fly ash, sand and mixtures thereof.

14. The shingle of claim 13, wherein said weather resistant coating of polymer is selected from a group of materials consisting of an epoxy, carbon (glassy), phenolic resin, a geopolymer and mixtures thereof.

15. The shingle of claim 13, wherein said weather resistant coating of ceramic glaze is made from a material selected from a group consisting of silicate, calcium magnesium silicate, aluminum silicate, alumina silicate, limestone, calcite-ground limestone, clay, bentonite clay, coal combustion byproducts and mixtures thereof.

16. The shingle of claim 15, wherein said weather resistant ceramic glaze coating material includes a polymer.

17. The shingle of claim 9, wherein said weather resistant coating has a thickness of between about 0.5 mm and about 7.0 mm and said coated reticulated foam body has a density of between about 0.5 g/mL and about 3.0 g/mL.

18. A flooring tile, comprising:
a reticulated foam body including a weather resistant coating made from a material selected from a group consisting of a ceramic glaze and a ceramic and polymer glaze imparting a desired texture and color to an exposed face of said reticulated foam body.

19. A method of producing a building panel, comprising:
shaping a body of reticulated foam to a desired shape;
applying a first weather resistant coating to a surface of said shaped body of reticulated foam; and
firing said first weather resistant coating in order to cure and set said first weather resistant coating to said surface of said shaped body of reticulated foam.

20. The method of claim 19, further including drying said first weather resistant coating and applying a second weather resistant coating over said first weather resistant coating before firing.
